(19) United States
(12) Patent Application Publication
(10) Pub. No.: US 2014/0060229 A1
(43) Pub. Date: Mar. 6, 2014

(54) Automatic Commodity Transportation System

(71) Applicants: Zenghong Chen, Shenzhen (CN); Chunhao Wu, Shenzhen (CN); Kunhsien Lin, Shenzhen (CN); Minghu Qi, Shenzhen (CN); Zhenhua Guo, Shenzhen (CN); Yunshao Jiang, Shenzhen (CN)

(72) Inventors: Zenghong Chen, Shenzhen (CN); Chunhao Wu, Shenzhen (CN); Kunhsien Lin, Shenzhen (CN); Minghu Qi, Shenzhen (CN); Zhenhua Guo, Shenzhen (CN); Yunshao Jiang, Shenzhen (CN)

(73) Assignee: Shenzhen China Star Optoelectronics Technology Co., Ltd., Shenzhen (CN)

(21) Appl. No.: 13/643,091

(22) PCT Filed: Sep. 14, 2012
(86) PCT No.: PCT/CN12/81432

§ 371 Date: Oct. 24, 2012

(30) Foreign Application Priority Data
Sep. 6, 2012 (CN) CN 201210326699.1

(51) Int. Cl. B25J 13/08

(52) U.S. Cl. CPC B25J 13/08; Y10S 901/09
USPC 74/490.01; 901/9

(57) ABSTRACT

An automatic commodity transportation system, adapted for transporting glass substrate of a TFT-LCD of a liquid crystal display device, wherein the automatic commodity transportation system includes a plurality of storing cabinets, a plurality of storing trays removeably disposed within the cabinet, and a transporting apparatus, wherein the transporting apparatus is used to move the trays between different storing cabinets, the transporting device which includes a chassis. A robot arm is rotatably mounted onto the chassis. A protective arrangement is provided on the robot arm to stop the operation of the robot arm when the protective arrangement is triggered to sending out a signal. As the automatic commodity transportation system is arranged with an anti-collision device such that a collision with other moving or stationary part is therefore effectively lowered. As a result, the halt and maintenance resulted of a damaged rotary arm can be avoided, and the production will not be affected. In addition, with the protective arrangement mounted on the rotary arm, personal injury can be effectively prevented as the personnel are safeguarded.

### CROSS REFERENCE

This application is claiming a priority arisen from a patent application, entitled with “Automatic Commodity Transportation System”, submitted to China Patent Office on Sep. 6, 2012, designated with an Application Number 201210326699.1. The whole and complete disclosure of such patent application is hereby incorporated by reference.

### FIELD OF THE INVENTION

The present invention relates to a technical field of manufacturing of liquid crystal display device, and more particularly to an automatic commodity transportation system for transporting a TFT-LCD glass substrate between working stations.

### DESCRIPTION OF PRIOR ART

With the development of the technologies of the liquid crystal display device, the electronic device made with a liquid crystal display device for screen has become more and more popular. A liquid crystal display panel is a key component of the liquid crystal display device.

During the manufacturing of the liquid crystal display device, the glass substrate or panel is stored in a storing tray of a cabinet. Each of the cabinet and the transporting apparatus jointly configure the automatic commodity transportation system. The transporting apparatus can readily move the tray from one place to another.

A robot arm is a key component of the transporting apparatus. In the current transporting apparatus, a robot arm could be easily damaged during the operation as it can be hit or collide with another moving part. Once a robot arm is damaged, it may take a great deal of resources, including technicians and time, to replace and then put it into working order. In addition, during the maintenance, accident may happen if care and precautions are not taken, and people in front of the robot arm could be hurt.

### SUMMARY OF THE INVENTION

It is an object of the present invention to provide an automatic commodity transportation system in which any possibility of being collided or hit with other moving part during the operation could be effectively reduced. As a result, with the provision of the present invention, the resources for replacing a damaged robot arm can be readily saved, and the production and manufacturing of the liquid crystal display device will not be affected, and increased.

In addition, by the provision of the present invention, any personal injury resulted from being hit by the robot arm can be effectively avoided. Accordingly, the safety on the worksite is ensured for both the technicians and operators.

In order to resolve the technical issue encountered by the prior art, the present invention provides a technical solution by introducing an automatic commodity transportation system, adapted for transporting glass substrate of a TFT-LCD of a liquid crystal display device, wherein the automatic commodity transportation system includes a plurality of storing cabinets, a plurality of storing trays removeably disposed within the cabinet, and a transporting apparatus, wherein the transporting apparatus is used to move the trays between different storing cabinets, the transporting device which includes a chassis. A robot arm is rotatably mounted onto the chassis. A protective arrangement is provided on the robot arm to stop the operation of the robot arm when the protective arrangement is triggered to sending out a signal.

Preferably, wherein the robot arm includes supporting portion and a telescopic portion having one end attached to the supporting portion, and the other end attached to a turntable on the chassis.

Preferably, wherein the supporting portion includes a pair of supporting fork arranged in parallel, and the protecting arrangement is an infrared sensor mounted onto the rods.

Preferably, wherein the infrared sensor includes a transmitter mounted on an end of a first prong of the fork, and a receiver mounted onto an end of the other prong of the fork.

Preferably, wherein the supporting portion includes a pair of supporting rod arranged in parallel with an anti-collision device mounted onto the supporting fork.

Preferably, wherein the anti-collision device encloses the supporting fork.

Preferably, wherein the automatic commodity transportation system includes an isle with the cabinets arranged on sides of the isle, and the transportation apparatus moves along the isle.

According to the automatic commodity transportation system, a transporting apparatus is provided and which includes a chassis and a robot arm. The rotary arm is provided with a protective arrangement which can issue a signal to stop the operation of the robot arm. With this, collision with other moving or stationary object can be effectively avoided, and laborious and expensive cost associated therewith can be also avoided. Accordingly, the production will not be interrupted. Meanwhile, the protective arrangement can also prevent the technician and maintenance personnel be injured as it by a moving or rotational robot arm. Again, the safety of the personnel is a safeguarded.

### BRIEF DESCRIPTION OF PREFERRED EMBODIMENTS

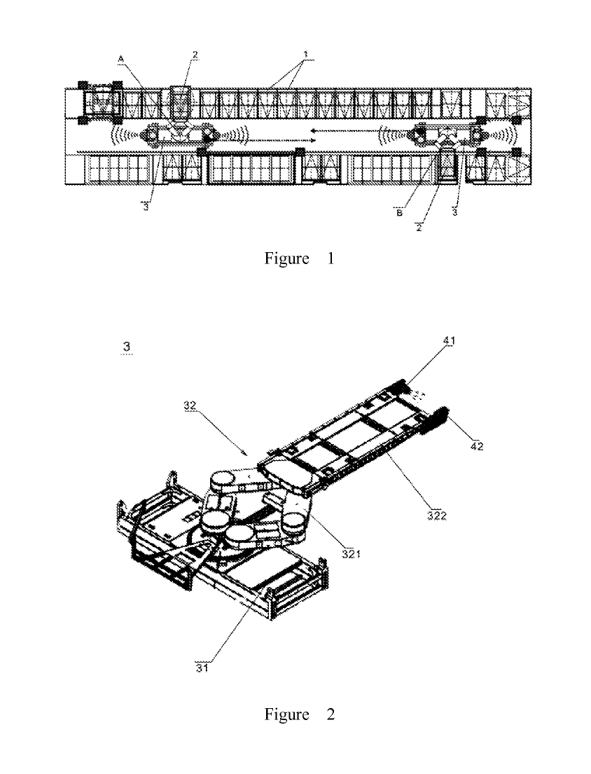

FIG. 1 is an illustrational and depictive drawing illustrating an automatic commodity transportation system made in accordance with the present invention;

FIG. 1 is an illustrational and structural drawing depicting a first embodiment of the automatic commodity transportation system made in accordance with the present invention; and

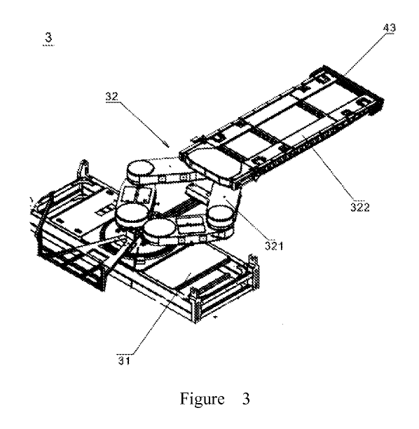

FIG. 3 is an illustrational and structural drawing depicting a second embodiment of the automatic commodity transportation system made in accordance with the present invention.

### DETAILED DESCRIPTION OF PREFERRED EMBODIMENTS

Detailed description will be given in view of the accompanied drawings.

The present invention provides an automatic commodity transportation system which includes a plurality of storing cabinets 1, a plurality of trays 2 removeably disposed within the cabinet 1, and a transporting apparatus 3 which moves the tray 2 between the cabinets 1. The transporting apparatus 3 includes:

A chassis 31;

A robot arm 32 is mounted onto the chassis 31 and on which a protective arrangement is provided. The protective arrangement can issue a signal to stop the operation of the robot arm 32 when the protective arrangement is triggered.

With a protective arrangement disposed onto the robot arm 32 of the automatic commodity transportation system, it can effectively prevented from a collision of the robot arm 32 with other moving or stationary object. Accordingly, with this, collision with other moving or stationary object can be effectively avoided, and laborious and expensive cost associated therewith can be also avoided. Accordingly, the production will not be interrupted. Meanwhile, the protective arrangement can also prevent the technician and maintenance personnel be injured as it by a moving or rotational robot arm. Again, the safety of the personnel is a safeguarded. Detailed description will be given to the automatic commodity transportation system in view of the accompanied drawings.

Referring to FIG. 1, the cabinet 1 is used to store the glass substrate during the manufacturing of the liquid crystal display device. In worksite, the cabinet 1 can be arranged in a plurality of rows or columns so as to effectively use the estate of the floor. In the present embodiment, the cabinets 1 is arranged in upper and lower rows, and an isle is defined between the cabinets 1 for the displacement of the transporting apparatus 3.

The storing cabinet 1 has a cubic configuration in which a plurality of trays 2 can be removeably disposed therein. The transporting apparatus 3 will move the trays 2 between different cabinets 1 so as to make the effective use of the cabinets 1.

### First Embodiment

As shown in FIG. 2, the transporting apparatus 3 includes a chassis 21 and a robot arm 32. The chassis 31 can readily be driven to move back and forth along horizontal direction. In addition, the chassis 3 can be used to rise, lower, rotate and telescopically move the robot arm 32.

The robot arm 32 is mounted onto the chassis 31, and it is configured with a telescopic portion 321 and a supporting portion 322. One end of the telescopic portion 321 is attached to the supporting portion 322, and the other end is attached to a turntable of the chassis 31. As a result, the robot arm 32 can rotate with respect to the chassis 31. The supporting portion 322 includes a pair of supporting fork arranged in parallel to each other, and the protective arrangement is mounted thereon.

The moving procedures of the transporting apparatus 3 works as follow. The transporting apparatus 3 is moved to a pre-selected position A, and the robot arm 32 is lifted also to a preset position vertically. With the help of the telescopic portion 321, the supporting fork are moved to a position under the storing tray 2 and then lift up the tray 2, and then move the tray 2 out of the cabinet 1 as the telescopic portion 321 retracts. Subsequently, the turntable of the chassis 31 is rotated to change the direction of the robot arm 31. After the supporting fork is moved to a preset position, the transporting apparatus 3 starts to move along the isle and finally reaches to a preset position B. The reverse the procedures as described above, and then the tray 2 can be disposed into another cabinet 1 located at position B.

During the transportation of the tray 2 by the transporting apparatus 3, in case there is an obstacle standing in front of the path of the transporting apparatus 3 such that a collision may happen to the robot arm 32. In this situation, the protective arrangement or safety device will be triggered so as to stop the operation of the robot arm 32. As a result, the robot arm 32 will stop running with respect to the chassis 31.

Preferably, in the present embodiment, the protective arrangement includes an infrared sensor mounted on the supporting forks. The infrared sensor includes a transmitter 41 mounted on one of the prong of the fork, and a receiver 42 mounted on the other prong.

Preferably, the protective device includes an anti-collision device 43 enclosing the prongs of the fork, such as shown in FIG. 3.

### Second Embodiment 2

In this embodiment, this is a simulation of a situation in which maintenance technician or personnel is working on the robot arm 32. As a result, the infrared sensor and the anti-collision device can really be used to protect the safety of the maintenance technician.

For example, the maintenance technician is working in front of the robot arm 32, if the robot arm 32 is accidentally triggered to rotate, and reaches to the vicinity of the maintenance technician. Once either the transmitter or receiver are blocked, then the safety protective arrangement will be triggered to issue a signal to stop the operation of the robot arm 32. Furthermore, if the anti-collision device located on the front ends of the robot arm 32 is touched by the maintenance technician, a signal will be issued to stop the operation of the robot arm 32.

The infrared sensor or anti-collision device can readily used to protect the safety of the maintenance technician such that any safety issue relates to personal injury can be effectively lowered.

According to the automatic commodity transportation system can be concluded with the following advantages. A transporting apparatus of the automatic commodity transportation system is provided and which includes a chassis and a robot arm. The rotary arm is provided with a protective arrangement which can issue a signal to stop the operation of the robot arm. With this, collision with other moving or stationary object can be effectively avoided, and laborious and expensive cost associated therewith can be also avoided. Accordingly, the production will not be interrupted. Meanwhile, the protective arrangement can also prevent the technician and maintenance personnel be injured as it by a moving or rotational robot arm. Again, the safety of the personnel is a safeguarded.

1. An automatic commodity transportation system, adapted for transporting glass substrate of a TFT-LCD of a liquid crystal display device, wherein the automatic commodity transportation system includes a plurality of storing cabinets, a plurality of storing trays removeably disposed within the cabinet, and a transporting apparatus, wherein the transporting apparatus is used to move the trays between different storing cabinets, the transporting device including:
a chassis; and
a robot arm rotatably mounted onto the chassis, a protective arrangement provided on the robot arm to stop the operation of the robot arm when the protective arrangement is triggered to sending out a signal.

2. The automatic commodity transportation system as recited in claim 1, wherein the robot arm includes supporting portion and a telescopic portion having one end attached to the supporting portion, and the other end attached to a turntable on the chassis.

3. The automatic commodity transportation system as recited in claim 1, wherein the supporting portion includes a pair of supporting fork arranged in parallel, and the protecting arrangement is an infrared sensor mounted onto the forks.

4. The automatic commodity transportation system as recited in claim 3, wherein the infrared sensor includes a transmitter mounted on an end of a first prong of the fork, and a receiver mounted onto an end of the other prong of the fork.

5. The automatic commodity transportation system as recited in claim 3, wherein the supporting portion includes a pair of supporting rod arranged in parallel with an anti-collision device mounted onto the supporting fork.

6. The automatic commodity transportation system as recited in claim 3, wherein the anti-collision device encloses the supporting fork.

7. The automatic commodity transportation system as recited in claim 3, wherein the automatic commodity transportation system includes an isle with the cabinets arranged on sides of the isle, and the transportation apparatus moves along the isle.

8. An automatic commodity transportation system, adapted for transporting glass substrate of a TFT-LCD of a liquid crystal display device, wherein the automatic commodity transportation system includes a plurality of storing cabinets, a plurality of storing trays removeably disposed within the cabinet, and a transporting apparatus, wherein the transporting apparatus is used to move the trays between different storing cabinets, the transporting apparatus including:
a chassis; and
a robot arm rotatably mounted onto the chassis, a protective arrangement provided on the robot arm to stop the operation of the robot arm when the protective arrangement is triggered to sending out a signal, wherein the protecting arrangement includes an infrared sensor mounted onto the rotary arm.

9. The automatic commodity transportation system as recited in claim 8, wherein the rotary arm includes a supporting portion rotationally mounted onto a turntable of the chassis, and the supporting portion includes a pair of supporting fork.

10. The automatic commodity transportation system as recited in claim 9, wherein the infrared sensor includes a transmitter mounted on an end of a first prong of the fork, and a receiver mounted onto an end of the other prong of the fork.

11. The automatic commodity transportation system as recited in claim 8, wherein the protecting arrangement includes an anti-collision device mounted onto the rotary arm.

12. The automatic commodity transportation system, wherein the rotary arm includes a supporting portion rotationally mounted onto a turntable of the chassis, and the supporting portion includes a pair of rods.

13. The automatic commodity transportation system as recited in claim 12, wherein the anti-collision device encloses the supporting fork.

14. An automatic commodity transportation system, adapted for transporting glass substrate of a TFT-LCD of a liquid crystal display device, wherein the automatic commodity transportation system includes a plurality of storing cabinets, a plurality of storing trays removeably disposed within the cabinet, and a transporting apparatus, wherein the transporting apparatus is used to move the trays between different storing cabinets, the transporting device including:
a chassis; and
a robot arm rotatably mounted onto the chassis, a protective arrangement provided on the robot arm so as to stop the operation of the robot arm when the protective arrangement is triggered to sending out a signal, wherein the protective arrangement includes an anti-collision device mounted onto the rotary arm.

15. The automatic commodity transportation system as recited in claim 14, wherein the rotary arm includes the supporting portion rotationally mounted onto a turntable of the chassis, and which includes a pair of supporting fork arranged in parallel to each other.

16. The automatic commodity transportation system as recited in claim 15, wherein the anti-collision device encloses the supporting fork.

17. The automatic commodity transportation system as recited in claim 14, wherein the protecting arrangement includes an infrared sensor mounted onto the rotary arm.

18. The automatic commodity transportation system as recited in claim 17, wherein the rotary arm includes a supporting portion rotationally mounted onto a turntable of the chassis, and the supporting portion includes a pair of supporting fork arranged in parallel to each other.

19. The automatic commodity transportation system as recited in claim 18, wherein the infrared sensor includes a transmitter mounted on an end of a first prong of the fork, and a receiver mounted onto an end of the other prong of the fork.
